(19) United States
(12) Patent Application Publication
(10) Pub. No.: US 2014/0195233 A1
(43) Pub. Date: Jul. 10, 2014

(54) Distributed Speech Recognition System

(71) Applicant: SPANSION LLC, Sunnyvale, CA (US)

(72) Inventor: Ojas Ashok BAPAT, Sunnyvale, CA (US)

(73) Assignee: Spansion LLC, Sunnyvale, CA (US)

(21) Appl. No.: 13/736,618

(22) Filed: Jan. 8, 2013

(51) Int. Cl. G10L 15/00

(52) U.S. Cl. CPC G10L 15/00
USPC 704/246

(57) ABSTRACT

Embodiments of the present invention include an apparatus, method, and system for speech recognition of a voice command. The method can include receiving data representing a voice command, generating a list of targets based on the state information of each target within the system, and selecting a target from the list of targets, based on the voice command.

### BACKGROUND

1. Field of Art

Embodiments of the present invention generally relate to speech recognition. More particularly, embodiments of the present invention relate to executing voice commands on an intended target device. Controlling or operating individual target devices, via spoken commands using automated speech recognition, may be used in office automation, home environments, or other fields.

2. Description of the Background Art

As the processing power of computing devices continues to increase and the size of computing systems continues to decrease, speech recognition is increasingly used to control devices within a home or office. Initially, only computers could recognize spoken commands. But now there are models of cell phones, televisions, VCRs, lights, and security systems, just to name a few devices, that also allow users to control them using voice commands.

In order to more accurately recognize voice commands, many of these devices use a simplified language model. Each of these devices also needs to include both the ability to determine when other speech is not meant to be a command and the ability to differentiate its command from commands for other devices. For example, each device needs to filter interpreting conversations that are taking place close to the devices as well as voice commands meant for other devices. Thus, speech recognition can be a processor intensive process.

In addition, these voice recognition systems must also address other issues related to the environment where the user is located. These issues can include echoes, reverberations, and ambient noise. These issues can be environment or room dependent. For example, the ambient noise within a busy room will be different that within a relatively quiet room and the echo within a large conference room will be different than within a smaller office.

### SUMMARY

Therefore, there is a need to offload processor intensive common speech recognition algorithms to a central processing environment while also allowing the flexibility of addressing some of the environment specific processing on the data representing the voice command by distributed systems within the environment.

Thus, an embodiment includes a method for speech recognition of a voice command to be executed on an intended target. The method can include receiving data representing a voice command, generating a list of targets based on state information of each target, and selecting a target from the list of targets based on the voice command.

Another embodiment includes an apparatus for speech recognition of a voice command. The apparatus can include a data reception module, a list generation module, and a target selection module. The data reception module can be configured to receive data representing a voice command. The list generation module can be configured to generate a list of possible targets based on a state of the targets. The target selection module can be configured to select the intended target based on both the list of possible targets and the voice command.

Further features and advantages of the invention, as well as the structure and operation of various embodiments of the present invention, are described in detail below with reference to the accompanying drawings. It is noted that the invention is not limited to the specific embodiments described herein. Such embodiments arc presented herein for illustrative purposes only. Additional embodiments will be apparent to persons skilled in the relevant art based on the teachings contained herein.

### BRIEF DESCRIPTION OF THE DRAWINGS

The accompanying drawings, which are incorporated herein and form a part of the specification, illustrate some embodiments and, together with the description, further serve to explain the principles of the invention and to enable a person skilled in the relevant art to make and use the invention.

FIG. 1 is an illustration of an exemplary communication system in which embodiments can be implemented.

FIG. 2 is an illustration of an exemplary environment in which embodiments can be implemented.

FIG. 3 is an illustration of a method of decoding a voice instruction according to an embodiment of the present invention.

FIG. 4 is an illustration of a method of target selection for decoding a voice instruction according to an embodiment of the present invention.

FIG. 5 is illustration of an example computer system in which embodiments of the present invention, or portions thereof, can be implemented as computer readable code,

### DETAILED DESCRIPTION

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the scope of the invention. Rather, the scope of the claimed subject matter is defined by the appended claims.

It would be apparent to a person skilled in the relevant art that the present invention, as described below, can be implemented in many different embodiments of software, hardware, firmware, and/or the entities illustrated in the figures. Thus, the operational behavior of embodiments of the present invention will be described with the understanding that modifications and variations of the embodiments are possible, given the level of detail presented herein.

This specification discloses one or more systems that incorporate the features of this invention. The disclosed systems merely exemplify the invention. The scope of the invention is not limited to the disclosed systems. The invention is defined by the claims appended hereto.

The systems described, and references in the specification to “one system”, “a system”, “an example system”, etc., indicate that the systems described may include a particular feature, structure, or characteristic, but every embodiment may not necessarily include the particular feature, structure, or characteristic. Moreover, such phrases are not necessarily referring to the same system. Further, when a particular feature, structure, or characteristic is described in connection with a system, it is understood that it is within the knowledge of one skilled in the art to affect such feature, structure, or characteristic in connection with other embodiments whether or not explicitly described.

For exemplary purposes, an embedded search algorithm is used to describe the apparatuses, systems, and methods below. A person of ordinary skill in the art would recognize that that these are merely examples and that the invention is useful in multiple other contexts.

### 1. Initiator/Target Communication System

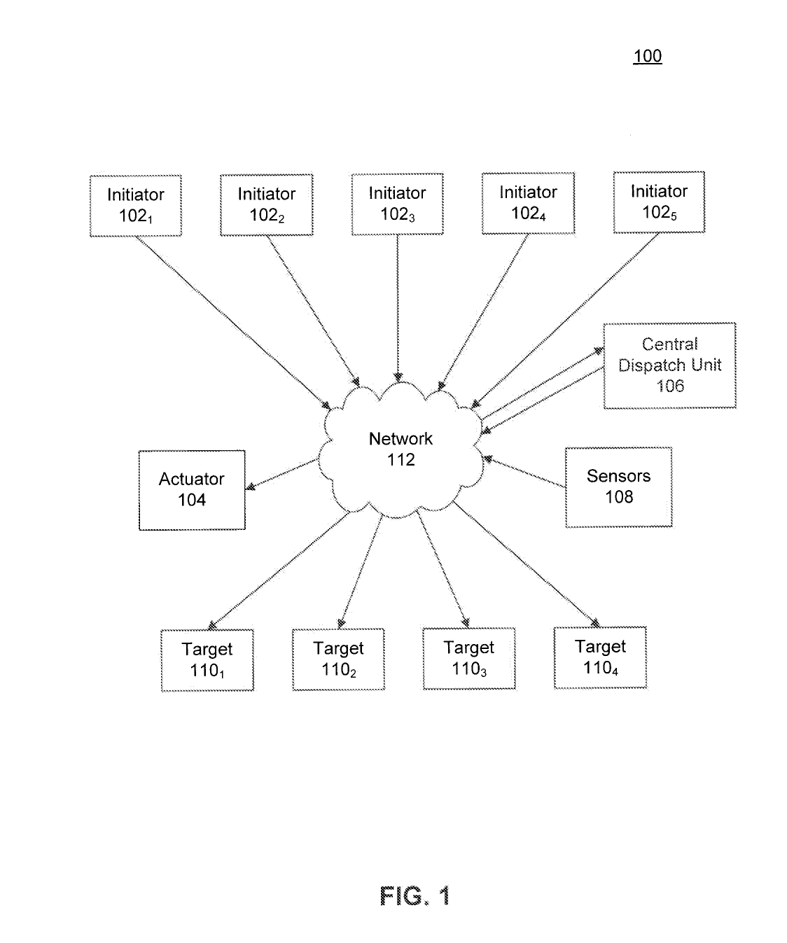

FIG. 1 is an illustration of an exemplary Communication System 100 in which embodiments described herein can be implemented. Communication System 100 includes Initiators 102₁-102₅ and Targets 110₁-110₄ that are communicatively coupled to a Central Dispatch Unit 106 via a Network 112. Sensors 108 and Actuators 104 are also communicatively coupled to Central Dispatch Unit 106 via Network 112.

Initiators 102₁-102₅ can be, for example and without limitation, microphones, mobile phones, other similar types of electronic devices, or a combination thereof.

Targets 110₁-110₄ can be, for example and without limitation, televisions, radios, ovens, HVAC units, microwaves, washers, dryers, dishwashers, other similar types of household and commercial devices, or a combination thereof.

Central Dispatch Unit 106 can be, for example and without limitation, a telecommunication server, a web server, or other similar types of database servers. In an embodiment, Central Dispatch Unit 106 can have multiple processors and multiple shared or separate memory components such as, for example and without limitation, one or more computing devices incorporated in a clustered computing environment or server farm. The computing process performed by the clustered computing environment, or server farm, can be carried out across multiple processors located at the same or different locations. In an embodiment, Central Dispatch Unit 106 can be implemented on a single computing device. Examples of computing devices include, but are not limited to, a central processing unit, an application-specific integrated circuit, field programmable gate array, or other types of computing devices having at least one processing unit and memory.

Sensors 108 can be, for example and without limitation, temperature sensors, light sensors, motion sensors, other similar types of sensory devices, or a combination thereof.

Actuator 104 can be, for example and without limitation, switches, mobile devices, other similar objects that can change the state of the targets, or a combination thereof.

Further, Network 112 can be, for example and without limitation, a wired (e.g., Ethernet) or a wireless (e.g., Wi-Fi and 3G) network, or a combination thereof that communicatively couples Initiators 102₁-102₅, Targets 110₁-110₄, Sensors 108, and Actuator 104 to Central Dispatch Unit 106.

In an embodiment, Communication System 100 can be a home-networked system (e.g., 3G and 4G mobile telecommunication systems). Users and the environment (e.g., through Initiators 102₁-102₅ and Sensors 108 of FIG. 1) can change (e.g., via Actuator 104 of FIG. 1) the state of devices (e.g., Targets 110₁-110₄ of FIG. 1). This can be done using a mobile telecommunication network (e.g., Network 112 of FIG. 1) and a home network server (e.g., Central Dispatch Unit 106 of FIG. 1).

In an embodiment, Communication System 100 can remove one or more ambient conditions from the received data, For example, it can cancel noise, such as background or ambient noise, cancel echoes, remove reverberations from the data, or a combination thereof. In an embodiment, the removal of the ambient conditions can be done by Initiators 102₁-102₅, Central Dispatch Unit 106, other devices in Network 112, or a combination thereof.

### 2. Exemplary Home Environment

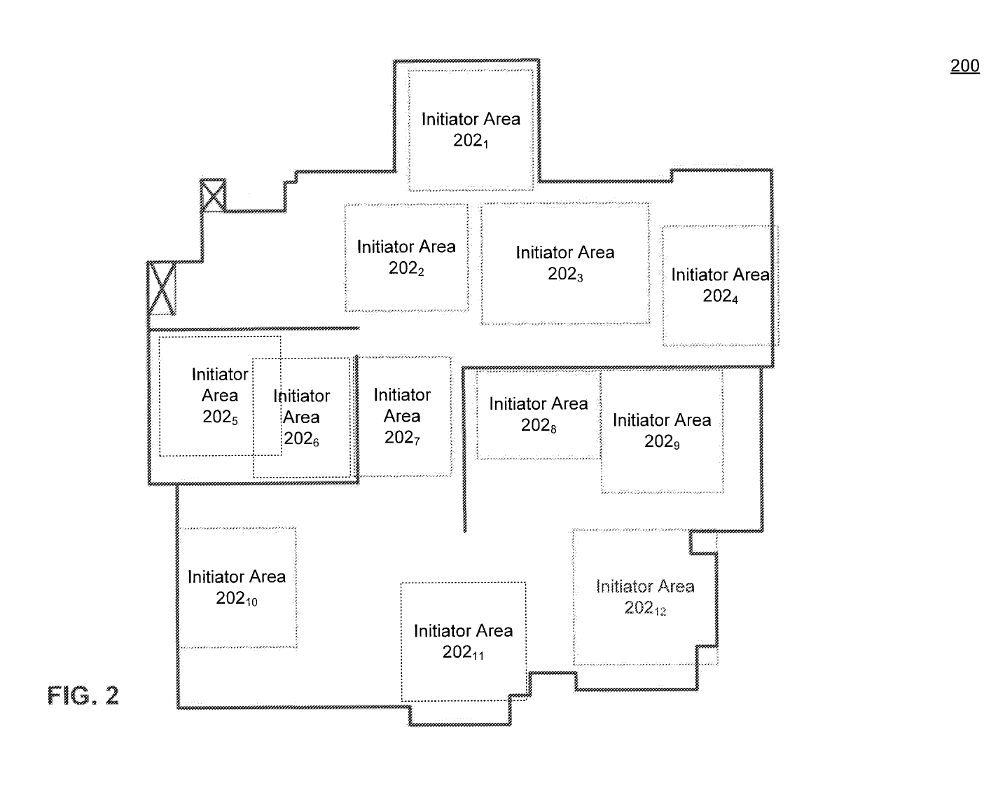

FIG. 2 is an illustration of an exemplary Home Environment 200 in which embodiments herein can be implemented. Home Environment 200 includes initiator Areas 202₁-202₁₂, each of which can be associated with one or more Initiators 102. Each Initiator Area 202₁-202₁₂ represents the area from which one or more Initiators 102 can receive input.

As illustrated in FIG. 2, Initiator Areas 202₁-202₁₂ can cover most of the area in the house, but need not cover the entire house. Also, as illustrated in FIG. 2, Initiator Areas 202₁-202₁₂ can overlap.

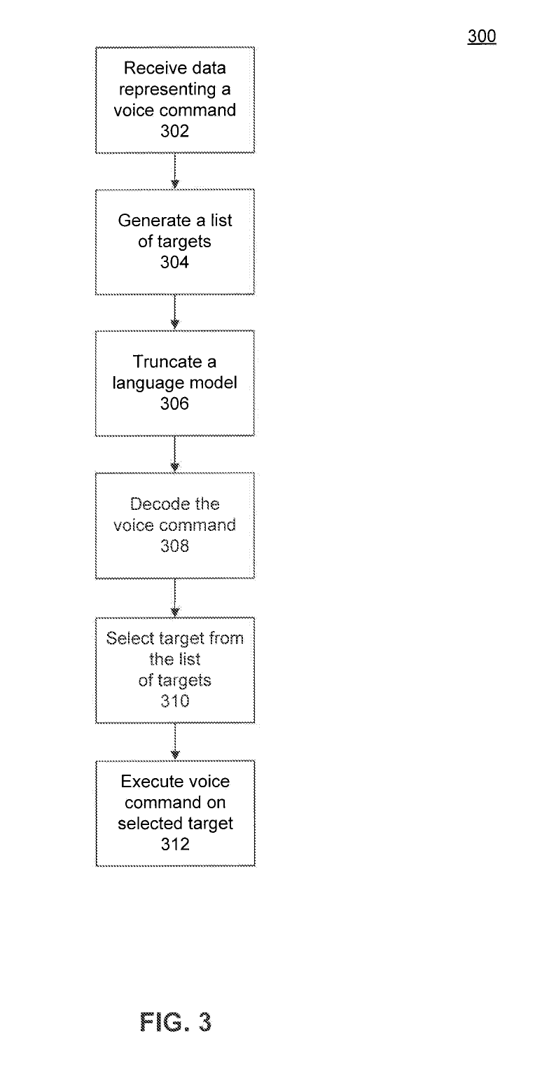

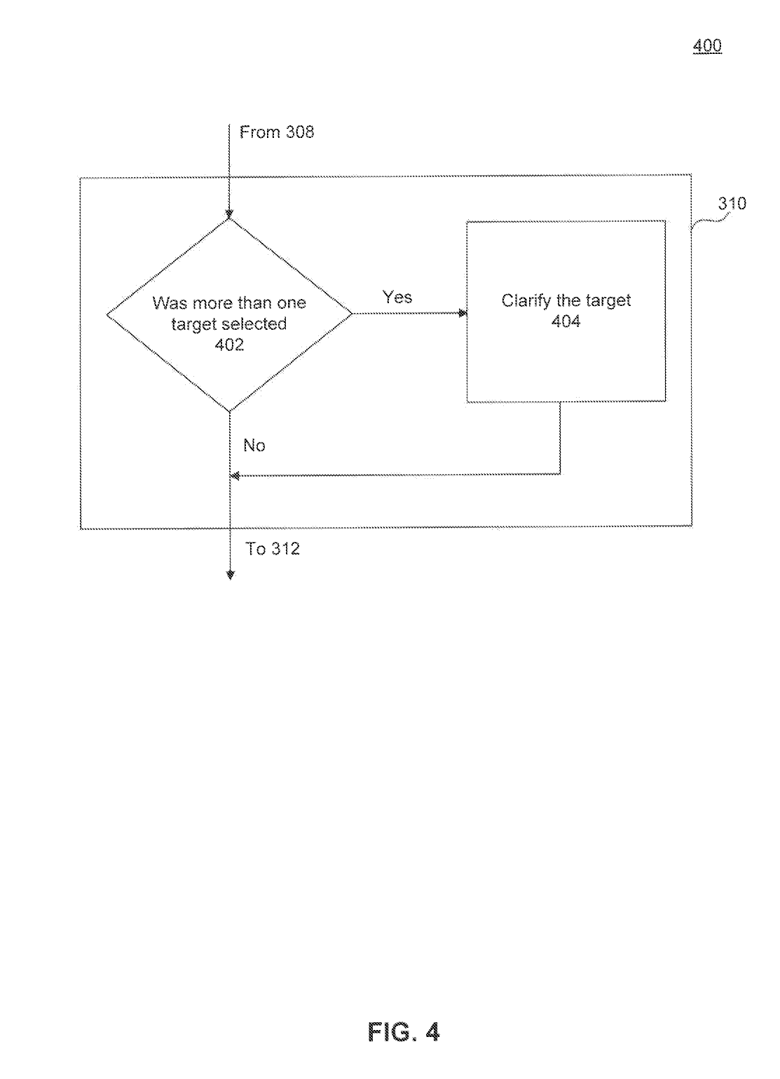

The following description of FIGS. 3 and 4 is based on a home/office environment similar to Home Environment 200. Based on the description herein, a person of ordinary skill in the relevant art will recognize that the embodiments disclosed herein can be applied to other types of environments such as, for example and without limitation, an airport, a train station, and a grocery store. These other types of environments are within the spirit and scope of the embodiments described herein.

### 3. Voice Command Execution Process

To allow users to more simply and efficiently use devices in their home or office, for example, flowchart 300 in FIG. 3 illustrates an embodiment of a process to determine a voice command using a truncated language model and to execute the command on an intended target.

As shown in FIG. 3, in step 302, an embodiment of the present invention receives data representing a voice command, for example by one or more Initiators 102₁-102₅ in FIG. 1.

In step 304, an embodiment of the present invention can generate a list of possible targets based on sensor information, state information, location of the initiator, other information, or a combination thereof. For example, if the sensors indicate that the temperature outside is 30 degrees Fahrenheit, the list of possible targets can include a heater, or if a light sensor indicates that it is night, the list of possible targets can include lights. In another example, if a TV and a radio are on (i.e., have a state “on”), then the list of possible targets can include the TV and radio since the voice command may be directed to these targets. In yet another example, if an initiator associated with a particular room (e.g., Initiator Areas 202₁-202₁₅) processes the voice command, then the targets associated with the particular room may be included in the list of possible targets.

In step 306, an embodiment can create a language model based on possible commands for targets within the environment. For example, in Home Environment 200 of FIG. 2 there may be a TV, HVAC unit, lights, and oven and, thus, the language model would include commands for the TV, HVAC unit, lights, and oven (e.g., “Turn up volume,” “Lower temperature,” “Dim lights,” and “Preheat oven”). After receiving the list of possible targets, an embodiment can truncate the language model to remove commands that are not applicable. For example, if the list of possible targets from step 304 does not include lights, then commands such as “Turn the lights on” and “Turn the lights off” can be truncated, or removed, from the language model.

In an embodiment, state information for the possible targets may also be used to truncate the language model. For example, the list of possible targets may include a TV. The state information may indicate that the TV is off currently (i.e., state “off”). In this example, commands such as “Change the channel to channel 10” or “Turn up the volume” associated with the TV having a state “on” can be truncated from the language model since these commands are not applicable to the state of the target. However, commands such as “Turn the TV on” associated with the TV having a state “off” may be kept since these commands are applicable to the current state of the target.

In step 308, an embodiment can decode the voice command based on the truncated language model. For example, if the TV is off currently, then commands associated with the TV having a state “off” (e.g., command “Turn the TV on”) are used to decode the voice command. Benefits, among others, of decoding the voice command based on the truncated language model include faster processing of the voice command and higher accuracy of processing the voice command correctly since a smaller language model is used.

In step 310, an embodiment can select a target from the list of possible targets based on the voice command. In an embodiment, the list of possible targets can include a single target (or “selected target) and flowchart 300 proceeds to step 312. For example, if the voice command data is “Turn the TV on” or “Change the TV to channel 12” and the list of targets includes a TV, an HVAC unit, a radio, and a lamp, it can be determined that the command is intended to be executed on the TV since the target is identified in the voice command data.

In another embodiment, the list of targets can include two or more targets. For example, voice commands such as, for example, “Turn on”, “Change channel”, and “Lower volume” can be applicable to a TV and a radio. In an embodiment, step 310 narrows the list of possible targets to a single target (or “selected target”). Flowchart 400 in FIG. 4 illustrates an embodiment of a process to select a single target.

In step 402, if more than one target is selected, an embodiment can continue to step 404 to clarify which target was intended. For example, if the voice command is “Turn the volume up” and the target list includes both a TV and a radio, the embodiment can continue to step 404.

In step 404, an embodiment can use one or more decision criterion to determine which target in the list of possible targets is the intended target. In one example, an embodiment can ask the user to clarify whether the TV or radio was the intended target. In another example, if the voice command is “Turn the volume up” and if the TV is on (i.e., state “on”) and the radio is off (i.e., state “off”), an embodiment can return the TV as the selected target to step 312 to execute “Turn the volume up” on the TV.

An embodiment can learn from past events when the same or a similar situation occurred to determine which target is the intended target. In an embodiment, the system may learn how to select between targets based on one or more past selections. For example, the user may have two lights in one room. In the past, the user may have said “Turn the light on” and the system may have requested clarification about which light. Based on the user's past clarifications, the system may learn to turn one of the lights on.

In another embodiment, the system may also learn to make a selection or limit the possible target list based on the location of the user. For example, if the user is in the kitchen, where there is no TV, and says “Turn the TV on,” the system may initially need clarification about whether the user meant the TV in the living room or the one in the bedroom. Based on the user's location, the system may learn to turn on the TV in the living room if the user makes the request from the kitchen.

In reference to flowchart 300 in FIG. 3, in step 312, an embodiment can execute the voice command on the selected target. An embodiment can use actuators to change the state of different targets. Actuators can be located in the target, such as the power switch and volume control for a TV, away from the target, such as a light switch for an overhead light, or in a centralized area, such as a home entertainment server or mobile device.

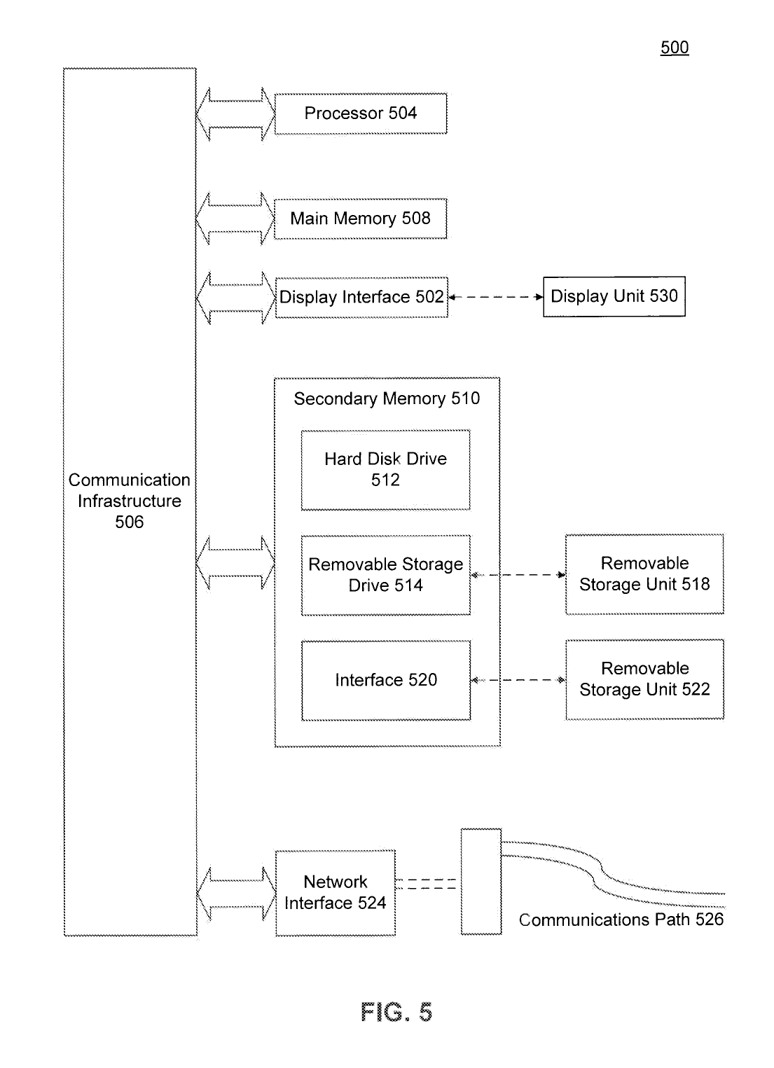

Based on the description herein, a person of ordinary skill in the relevant art will recognize that steps 302-312 of FIG. 3 can be executed on one or more processing modules. In an embodiment, these processing modules include a data reception module, a list generation module, a language truncation module, a voice decoder, a target generation module, and a task execution module to perform steps 302, 304, 306, 308, 310, and 312, respectively. These processing modules can be integrated into a computer system such as, for example, computer system 500 of FIG. 5 (described in detail below). Further, in reference to Communication System 100 of FIG. 1, the data reception module, list generation module, voice decoder, target generation module, and task execution module can be integrated into Initiator 102, Central Dispatch Unit 106, Actuator 104, or a combination thereof.

### 4. Exemplary Computer System

Various aspects of the present invention may be implemented in software, firmware, hardware, or a combination thereof FIG. 5 is an illustration of an example computer system 500 in which embodiments of the present invention, or portions thereof, can be implemented as computer-readable code. For example, the method illustrated by flowchart 300 of FIG. 3 and the method illustrated by flowchart 400 of FIG. 4 can be implemented in system 500. Various embodiments of the present invention are described in terms of this example computer system 500. After reading this description, it will become apparent to a person skilled in the relevant art how to implement embodiments of the present invention using other computer systems and/or computer architectures.

It should be noted that the simulation, synthesis and/or manufacture of various embodiments of this invention may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a memory.

Computer system 500 includes one or more processors, such as processor 504. Processor 504 may be a special purpose or a general-purpose processor. Processor 504 is connected to a communication infrastructure 506 (e.g., a bus or network).

Computer system 500 also includes a main memory 508, preferably random access memory (RAM), and may also include a secondary memory 510. Secondary memory 510 can include, for example, a hard disk drive 512 a removable storage drive 514, and/or a memory stick, Removable storage drive 514 can include a floppy disk drive, a magnetic tape drive, an optical disk drive, a flash memory, or the like. The removable storage drive 514 reads from and/or writes to a removable storage unit 518 in a well-known manner, Removable storage unit 518 can comprise a floppy disk, magnetic tape, optical disk, etc. which is read by and written to by removable storage drive 514. As will be appreciated by persons skilled in the relevant art, removable storage unit 518 includes a computer-usable storage medium having stored therein computer software and/or data.

Computer system 500 (optionally) includes a display interface 502. (which can include input and output devices such as keyboards, mice, etc) that forwards graphics, text, and other data from communication infrastructure 506 (or from a frame buffer not shown) for display on display unit 530.

In alternative implementations, secondary memory 510 can include other similar devices for allowing computer programs or other instructions to be loaded into computer system 500. Such devices can include, for example, a removable storage unit 522 and an interface 520. Examples of such devices can include a program cartridge and cartridge interface (such as those found in video game devices), a removable memory chip (e.g., EPROM or PROM) and associated socket, and other removable storage units 522 and interfaces 520 which allow software and data to be transferred from the removable storage unit 522 to computer system 500.

Computer system 500 can also include a communications interface 524. Communications interface 524 allows software and data to be transferred between computer system 500 and external devices. Communications interface 524 can include a modem, a network interface (such as an Ethernet card), a communications port, a PCMCIA slot and card, or the like. Software and data transferred via communications interface 524 are in the form of signals which may be electronic, electromagnetic, optical, or other signals capable of being received by communications interface 524. These signals are provided to communications interface 524 via a communications path 526. Communications path 526 carries signals and can be implemented using wire or cable, fiber optics, a phone line, a cellular phone link, a RF link or other communications channels.

In this document, the terms “computer program medium” and “computer-usable medium” are used to generally refer to media such as removable storage unit 518, removable storage unit 522, and a hard disk installed in hard disk drive 512. Computer program medium and computer-usable medium can also refer to memories, such as main memory 508 and secondary memory 510, which can be memory semiconductors (e.g., DRAMs, etc.). These computer program products provide software to computer system 500.

Computer programs (also called computer control logic) are stored in main memory 508 and/or secondary memory 510. Computer programs may also be received via communications interface 524. Such computer programs, when executed, enable computer system 500 to implement embodiments of the present invention as discussed herein. In particular, the computer programs, when executed, enable processor 504 to implement processes of embodiments of the present invention, such as the steps in the method illustrated by flowchart 300 of FIG. 3 and the method illustrated by flowchart 400 of FIG. 4 can be implemented in system 500, discussed above. Where embodiments of the present invention are implemented using software, the software can be stored in a computer program product and loaded into computer system 500 using removable storage drive 514, interface 520, hard drive 512, or communications interface 524.

Embodiments of the present invention are also directed to computer program products including software stored on any computer-usable medium. Such software, when executed in one or more data processing device, causes a data processing device(s) to operate as described herein. Embodiments of the present invention employ any computer-usable or -readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano technological storage devices, etc.), and communication mediums (e.g., wired and wireless communications networks, local area networks, wide area networks, intranets, etc.).

### 5. Conclusion

it is to be appreciated that the Detailed Description section, and not the Summary and Abstract sections, is intended to be used to interpret the claims. The Summary and Abstract sections may set forth one or more but not all exemplary embodiments of the present invention as contemplated by the inventors, and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the relevant art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for speech recognition comprising:
receiving data representative of a voice command;
generating a list of one or more targets based on state information associated with each of the one or more targets; and
selecting a target from the list of targets based on the voice command.

2. The method according to claim 1, further comprising:
executing the voice command on the selected target.

3. The method according to claim 1, further comprising:
truncating a language model based on the list of targets; and
decoding the voice command using the truncated language.

4. The method according to claim 3, wherein the truncating the language model comprises removing one or more portions of the language model based on an identification of the list of targets, state information of the list of targets, sensor information associated with the list of targets, or a combination thereof

5. The method according to claim 1, wherein the receiving comprises removing one or more ambient conditions from the data.

6. The method according to claim 5, wherein the removing comprises canceling noise, canceling an echo, removing reverberation from the data, or a combination thereof.

7. The method according to claim 1, wherein the receiving comprises receiving the data from one of a plurality of locations.

8. The method according to claim 1, wherein the selecting comprises choosing the selected target based on a learning algorithm that incorporates a learning algorithm that incorporates one or more past selections of the selected targets, a location from where the data was received, or a combination thereof

9. The method according to claim 1, wherein the selecting comprises requesting user clarification to select one target when two or more selected targets are present.

10. An apparatus for speech recognition comprising:
a data reception module configured to receive data representative of a voice command;
a list generation module configured to generate a list of one or more targets based on state information associated with each of the one or more targets; and
a target selection module configured to select a target from the list of targets based on the voice command.

11. The apparatus according to claim 10, further comprising:
a task execution module configured to execute the voice command on the selected target.

12. The apparatus according to claim 10, further comprising:
a language truncation module configured to truncate a language model based on the list of targets; and
a voice decoder configured to decode the voice command using the truncated language model.

13. The apparatus according to claim 12, wherein the language truncation module is configured to remove one or more portions of the language model based on an identification of the list of targets, state information of the list of targets, sensor information associated with the list of targets, or a combination thereof.

14. The apparatus according to claim 10, wherein the data reception module is configured to remove one or more ambient conditions from the data.

15. The apparatus according to claim 10, wherein the data reception module is configured to receive the data from one of a plurality of locations.

16. The apparatus according to claim 10, further comprising:
a target clarification module configured to identify the selected target if the target selection module selects more than one target from the list of targets;
wherein the target selection module is configured to learn how to identify the selected target based on a learning algorithm that incorporates one or more past selections of the selected targets, a location from where the data was received, or a combination thereof.

17. A computer program product comprising a computer-usable medium having computer program logic recorded thereon that, when executed by one or more processors, processes a plurality of data representations of voice commands in a speech recognition system, the computer program logic comprising:
a first computer readable program code that enables a processor to receive data representative of a voice command;
a second computer readable program code that enables a processor to generate a list of one or more targets based on state information associated with each of the one or more targets; and
a third computer readable program code that enables a processor to select a target from the list of targets based on the voice command.

18. The computer program product to claim 17, further comprising;
a fourth computer readable program code that enables a processor to execute the voice command on the selected target.

19. The computer program product to claim 17, further comprising:
a fifth computer readable program code that enables a processor to truncate a language model based on the list of targets;
a sixth computer readable program code that enables a processor to truncate the language model based on the list of targets, target state of the targets, or sensor information; and
a seventh computer readable program code that enables a processor to decode the voice command using the truncated language.

20. The computer program product to claim 17, wherein the third computer readable program code comprises requesting user clarification to select one target when two or more selected targets are present.
